(19) United States
(12) Patent Application Publication
(10) Pub. No.: US 2025/0233839 A1
(43) Pub. Date: Jul. 17, 2025

(54) DOCUMENT BLOCK SHARING METHOD AND APPARATUS, SYSTEM AND STORAGE MEDIUM

(71) Applicant: Beijing Zitiao Network Technology Co., Ltd., Beijing (CN)

(72) Inventors: Yan Jiang, Beijing (CN); Yonghao Zhang, Beijing (CN); Hongye Qi, Beijing (CN); Ran Yan, Beijing (CN)

(21) Appl. No.: 18/849,472

(22) PCT Filed: Mar. 20, 2023
(86) PCT No.: PCT/CN2023/082537

§ 371 Date: Sep. 20, 2024

(30) Foreign Application Priority Data
Mar. 22, 2022 (CN) 202210287503.6

(51) Int. Cl. H04L 51/10

(52) U.S. Cl. CPC H04L 51/10

(57) ABSTRACT

Embodiments of the present disclosure relate to a document block sharing method and apparatus, a system and a storage medium. In at least one embodiment of the present disclosure, after a document block is selected, the document block may be directly shared in a document to other business scenarios in a collaborative office platform, the other business scenarios include a chat scenario, a mail scenario, a to-do task scenario, a video conference scenario, and the like. For example, based on an operation of directly sharing the document block to a chat in the document, a sharing interface including an instant message chat list is presented, so that a user can conveniently select at least one chat to receive the document block, and then send the document block to the selected at least one chat. Therefore, the user can complete document block sharing without the need to switch between the document and an IM client, thereby simplifying the operation.

### CROSS-REFERENCE TO RELATED APPLICATION(S)

This application claims priority to Chinese Application No. 202210287503.6, filed on Mar. 22, 2022, and entitled “Document Block Sharing Method and Apparatus, System and Storage Medium”, the disclosure of which is incorporated herein by reference in its entity.

### FIELD

Embodiments of the present disclosure relate to the technical field of computers, and in particular to a document block sharing method and apparatus, a system and a storage medium.

### BACKGROUND

At present, a user often needs to quickly share local document content (referred to as a document block, Block) to a chat, which is referred to as document block sharing. However, in practice, the user needs to perform screenshot on the document block in a document at first, then switch from the document to an instant message (IM) client, and copy and paste the screenshot of the document block into the chat to complete the document block sharing, thereby being cumbersome in operation.

### SUMMARY

In order to solve at least one problem in the prior art, at least one embodiment of the present disclosure provides a document block sharing method and apparatus, and system and storage medium.

In a first aspect, an embodiment of the present disclosure provides a document block sharing method, including: presenting a sharing interface in response to a sharing operation triggered for a document block in a first document; determining a target business scenario based on a selection operation on the sharing interface; and in response to a sharing confirmation operation, sending a document block indicated by the sharing operation to the target business scenario, wherein the document block indicated by the sharing operation includes one or more document blocks.

In some embodiments, determining the target business scenario based on the selection operation on the sharing interface includes: determining a target chat based on a chat selection operation on the sharing interface; and sending the document block indicated by the sharing operation to the target business scenario includes: sending, to the target chat, the document block indicated by the sharing operation.

In some embodiments, the method further includes: before presenting the sharing interface in response to the sharing operation triggered for the document block in the first document, presenting a document block operation option box in response to a selection operation on the document block in the first document, wherein the document block operation option box includes an option of sharing to a chat.

In some embodiments, the method further includes: acquiring permission information of the document block; and synchronizing the permission information to a system to which the target business scenario belongs, so that the system presents the document block in the target business scenario based on the permission information.

In some embodiments, acquiring the permission information of the document block includes: acquiring permission information of the first document as the permission information of the document block; or presenting a permission setting interface of the document block, and acquiring the permission information of the document block based on an operation on the permission setting interface, wherein when the first document includes a plurality of document blocks, permissions for the document blocks are set uniformly or separately in the permission setting interface.

In some embodiments, the method further includes: assigning a first permission for the document block to members in the target chat, wherein the first permission is to assign the same permission to the members in the target chat, or to assign different permissions the members in the target chat.

In some embodiments, the method further includes: in response to an operation of withdrawing the sent document block in the target chat, revoking the first permission assigned to the members in the target chat for the document block.

In some embodiments, the method further includes: further assigning a first permission for the first document to the members in the target chat while assigning the first permission for the document block to the members in the target chat.

In some embodiments, the method further includes: after presenting the sharing interface in response to the sharing operation triggered for the document block in the first document, in response to the sharing confirmation operation, acquiring a postscript input into a postscript box of the sharing interface, and sending the postscript into the target chat.

In some embodiments, the method further includes: in response to a trigger operation of a first user for the document block in the target chat, presenting the first document to the first user, and positioning to a location of the document block.

In a second aspect, an embodiment of the present disclosure further provides a document block sharing method, including: receiving an operation of sending a document block of a first document to a target chat; acquiring first permission information of the document block; and presenting, in an interface corresponding to individual member of the target chat, the document block in a preset present style based on the first permission information of the document block.

In some embodiments, the preset display style includes a text hyperlink and a message card; and the method further includes: after receiving the operation of sending the document block of the first document to the target chat, in response to the operation of sending the document block of the first document to the target chat, parsing the document block, generating a text hyperlink corresponding to the document block, and rendering, in the preset present style, a message card corresponding to the document block.

In some embodiments, the preset present style includes at least one of the following: a title bar, including the text hyperlink; a content area, in which part or all of content of the document block is displayed; or a permission area, including a permission setting control, wherein the permission setting control is used by the current user to set a permission of a chat member for the document block, or the permission area is used for displaying a permission of the current user for the document block.

In some embodiments, the method further includes: in response to an operation of triggering the document block presented in the target chat, opening a browser and skipping to the first document corresponding to the document block. In some embodiments, the method further includes: before opening the browser and skipping to the first document corresponding to the document block, determining whether a user triggering the operation has at least a reading permission for the first document; if so, executing the operation of opening the browser and skipping to the first document corresponding to the document block; and otherwise, presenting prompt information of applying for a permission for the first document. In some embodiments, presenting, in the interface corresponding to individual member of the target chat, the document block in the preset present style based on the first permission information of the document block, includes: in a case where the current user in the target chat has a readable permission or an editable permission for the document block in the first permission information, displaying part or all of content of the document block in the target chat of the current user; or in a case where the current user in the target chat has no permission for the document block in the first permission information, displaying, in the target chat of the current user, prompt information of applying for a permission.

In some embodiments, the method further includes: in response to an editing operation or a commenting operation on the document block in the target chat, detecting whether a member performing the editing operation or the commenting operation has an editable permission, and if so, adding edited content or commented content into the document block in the target chat.

In some embodiments, the method further includes: after adding the edited content or commented content into the document block in the target chat, synchronizing the edited content or commented content into the first document.

In a third aspect, an embodiment of the present disclosure further provides a document block sharing apparatus, including: a presentation unit, configured to present a sharing interface in response to a sharing operation triggered for a document block in a first document; a determination unit, configured to determine a target business scenario based on a selection operation on the sharing interface; and a sending unit, configured to: in response to a sharing confirmation operation, send a document block indicated by the sharing operation to the target business scenario, wherein the document block indicated by the sharing operation includes one or more document blocks.

In a fourth aspect, an embodiment of the present disclosure further provides a document block sharing apparatus, including: a receiving unit, configured to receive an operation of sending a document block of a first document to a target chat; an acquisition unit, configured to acquire first permission information of the document block; and a presentation unit, configured to: in an interface corresponding to individual member of the target chat, present the document block in a preset present style based on the first permission information of the document block.

In a fifth aspect, an embodiment of the present disclosure further provides a system, including at least one computing apparatus and at least one storage apparatus for storing an instruction, wherein the instruction causes, when operated by the at least one computing apparatus, the at least one computing apparatus to execute the steps of the document block sharing method in any embodiment of the first aspect or the document block sharing method in any embodiment of the second aspect.

In a sixth aspect, an embodiment of the present disclosure further provides a computer-readable storage medium, wherein the computer-readable storage medium stores a program or an instruction, and the program or the instruction, when operated by at least one computing apparatus, causes the at least one computing apparatus to execute the steps of the document block sharing method in any embodiment of the first aspect or the document block sharing method in any embodiment of the second aspect.

It can be seen that in at least one embodiment of the present disclosure, after the document block is selected, the document block may be directly shared in the document to other business scenarios in a collaborative office platform, and the other business scenarios include a chat scenario, a mail scenario, a to-do task scenario, a video conference scenario, and the like. For example, based on an operation of directly sharing a document block to a chat in a document, a sharing interface is presented, and the sharing interface includes an instant message (IM) chat list, so that a user can conveniently select at least one chat to receive the document block, and then send the document block to the selected at least one chat. Therefore, the user can complete document block sharing without the need to switch between the document and an IM client, thereby simplifying the operation.

### BRIEF DESCRIPTION OF THE DRAWINGS

To illustrate technical solutions in the embodiments of the present disclosure more clearly, a brief introduction on the drawings which are needed in the description of the embodiments or the prior art is given below. Apparently, the drawings in the description below are merely some of the embodiments of the present disclosure, based on which other drawings may also be obtained by those ordinary skilled in the art without any creative effort.

FIG. 1 is a schematic diagram of sharing a document block provided in an embodiment of the present disclosure;

FIG. 2 is an another schematic diagram of sharing a document block provided in an embodiment of the present disclosure;

FIG. 3 is an exemplary flowchart of a document block sharing method provided in an embodiment of the present disclosure;

FIG. 4 is an exemplary flowchart of another document block sharing method provided in an embodiment of the present disclosure;

FIG. 5 is an exemplary flowchart of still another document block sharing method provided in an embodiment of the present disclosure;

FIG. 6 is a schematic diagram of a sharing interface provided in an embodiment of the present disclosure;

FIG. 7 is an exemplary flowchart of a document block sharing method provided in an embodiment of the present disclosure;

FIG. 8 is a schematic structural diagram of a text hyperlink provided in an embodiment of the present disclosure;

FIG. 9 is a schematic diagram of a preset present style of a message card provided in an embodiment of the present disclosure;

FIG. 10 is an exemplary flowchart of still another document block sharing method provided in an embodiment of the present disclosure;

FIG. 11 is an exemplary block diagram of a document block sharing apparatus provided in an embodiment of the present disclosure;

FIG. 12 is an exemplary block diagram of another document block sharing apparatus provided in an embodiment of the present disclosure; and

FIG. 13 is an exemplary block diagram of a system including at least one computing apparatus and at least one storage apparatus for storing an instruction provided in an embodiment of the present disclosure.

### DETAILED DESCRIPTION OF EMBODIMENTS

In order to understand the above objectives, features and advantages of the present disclosure more clearly, the present disclosure will be further described in detail below in combination with the drawings and embodiments. It can be understood that the the embodiments described below are merely a part, but not all, of the embodiments of the present disclosure. The specific embodiments described herein are merely used for explaining the present disclosure, rather than limiting the present disclosure. All of other embodiments, obtained by those ordinary skilled in the art based on the described embodiments in the present disclosure, fall into the protection scope of the present disclosure.

It should be noted that herein, relational terms, such as “first”, “second” and the like, are merely used for distinguishing one entity or operation from another entity or operation, and do not necessarily require or imply that any such actual relationship or sequence exists between these entities or operations.

A document and instant message (IM) are used as two important components of a collaborative office system suite, and the use efficiency and experience of a user for the suite may be effectively improved due to an improvement in a content circulation entry and link convenience thereof. However, for document block sharing, the user needs to switch back and forth between the document and an IM client for operation, which is very cumbersome and reduces the user experience. In addition, in other business scenarios of the collaborative office suite system such as mails, video conferences, tasks and the like, there is also a problem of low interaction efficiency with a document side.

Therefore, embodiments of the present disclosure provide a document block sharing method and apparatus, a system, or a storage medium. In at least one embodiment of the present disclosure, firstly, an operation of selecting a document block may be performed in a document to replace a screenshot operation, and a document block is obtained instead of a screenshot, thereby facilitating direct editing and comment on the content of the document block subsequently. Secondly, after the document block is selected, the document block may be directly shared in the document to other business scenarios in a collaborative office platform, and the other business scenarios include a chat scenario, a mail scenario, a to-do task scenario, a video conference scenario, and the like. For example, based on an operation of directly sharing the document block to a chat in the document, a sharing interface is presented, and the sharing interface includes an instant message chat list, so that the user can conveniently select at least one chat to receive the document block, and then send the document block to the selected at least one chat. Therefore, the user can complete document block sharing without the need to switch between the document and the IM client, thereby simplifying the operation. In addition, a message card including a text hyperlink is displayed in an interface of the chat, the text hyperlink and the message card are generated based on information of the document block, and key information, summary information and core information of content of the document block are substantially presented by using the message card, so as to help the user to quickly learn about the content of the document block, so that the content of the document block can be directly consumed without skipping, thereby improving the consumption efficiency of the content of the document block.

A document block (also referred to as a document Block) refers to an information entity in a document, which may be created by the user and has explicit meaning, for example, a piece of text, a picture, a table, or a combination thereof. The document block may be understood as an information entity of a variety of content types in the document. That is, on a document side, the content of the document is organized and managed based on these information entities.

The document Block is implemented based on a frame for operating the Block, and the frame is referred to as Blockit. Blockit is a set of standards, which allows a three-party application (e.g., a document application) to open internal information, converts the internal information into a piece of data of a standard format, and provides a component to display the piece of data. This “piece of data” is referred to as a BlockEntity, and a view is referred to as a Block View. The BlockEntity and the Block View are combined together to form a “widget” Block.

The Blockit is a frame for operating the Block. The Blockit includes two parts, that is, a Blockit Server and a BlockIT SDK. The BlockIT Server provides data synchronization among a three-party data source, the BlockEntity and the Block View. The Blockit SDK provides a unified operating environment for the Block View, and the user may operate the Block as long as integrating the Blockit SDK.

The BlockIT server provides API and event subscription (Webhook) for the outside, and supports two-way synchronization of third-party data via an HTTP request. On the other hand, an internal long link is established between the Blockit Server and the BlockIT SDK for operating the Block to perform two-way data synchronization. In this way, from a third-party data source to a final view seen by the user, a data transmission link therein is completely provided by the BlockIt.

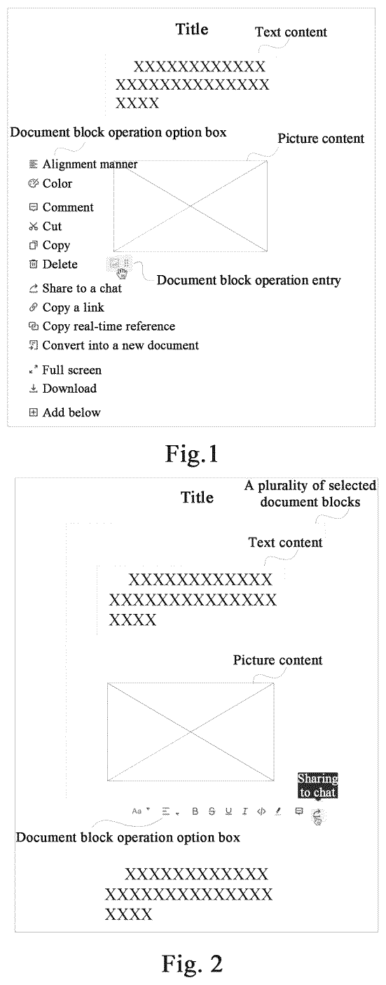

FIG. 1 is a schematic diagram of sharing a document block provided in an embodiment of the present disclosure. In FIG. 1, the user selects a picture document block, a document block operation entry is presented in the vicinity the document block, and when the user hovers a mouse pointer to the document block operation entry, a document block operation option box is further presented. The document block operation option box includes an option of sharing to a chat, and the user may click the option to share the document block.

FIG. 2 is an another schematic diagram of sharing a document block provided in an embodiment of the present disclosure. In FIG. 2, the user may select a plurality of document blocks. After the plurality of document blocks are selected, the document block operation option box is directly presented in the vicinity of the document block, the document block operation option box includes an option of sharing to a chat, and when the user hovers the mouse pointer to the option of sharing to the chat, “sharing to the chat” is prompted, and the user may click the option to share the plurality of selected document blocks.

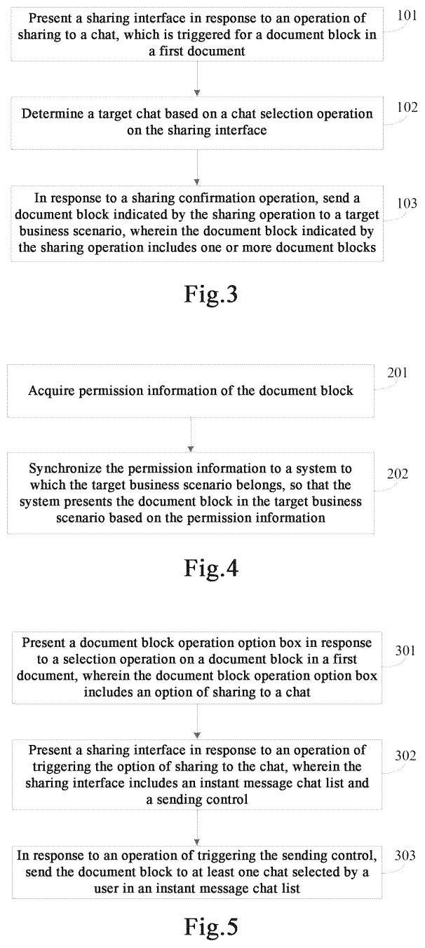

FIG. 3 is an exemplary flowchart of a document block sharing method provided in an embodiment of the present disclosure. The document block sharing method is applied to a document side. The document block sharing method may include, but is not limited to, the following steps 101 to 103:

In step 101, a sharing interface is presented in response to a sharing operation triggered for a document block in a first document.

In the present embodiment, after selecting the document block, the user may directly perform an operation of sharing the document block in a document page. The document block is local document content. The document block may include a text and/or a picture. The sharing interface is an interface presented in the document page.

In step 102, a target business scenario is determined based on a selection operation on the sharing interface.

The target business scenario may be an IM chat scenario, a mail scenario, a task scenario, a video conference scenario, and the like. The selection operation may be a chat selection operation, a mail selection operation, a task selection operation, a video conference selection operation, etc.

In step 103, in response to a sharing confirmation operation, a document block indicated by the sharing operation is sent to the target business scenario, and the document block indicated by the sharing operation includes one or more document blocks.

In the present embodiment, a sharing confirmation control is displayed in the sharing interface, and after confirming that the selected target business scenario is correct, the user may execute the sharing confirmation operation, for example, click the sharing confirmation control. In response to the user clicking the sharing confirmation control, the document block indicated by the sharing operation is sent to the target business scenario.

Taking it as an example that the business scenario is a chat in IM, an execution body of the document block sharing method respectively interacts with a document and an instant message client (that is, an IM client), and represents a sharing interface in response to an operation of triggering to share a document block in a first document to the chat; determines a target chat based on a chat selection operation on the sharing interface; and sends, to the target chat, a document block indicated by the sharing operation.

Taking it as an example that the business scenario is a chat in IM, an instant message chat list is presented in the sharing interface, the instant message chat list is a chat list in the IM client, and the chat list is, for example, a latest chat list of the user. The user may select at least one chat from the instant message chat list to receive the document block, the sharing interface may further include a selected area, and at least one chat selected by the user is displayed in the selected area. The chat displayed in the selected area is the target chat, and the target chat may be one or more chats.

It can be seen that in the present embodiment, after the document block is selected, the operation of sharing the document block to the chat may be directly performed in the document, the sharing interface is presented, and the sharing interface includes the instant message chat list, so that the user can conveniently select at least one chat to receive the document block, and then send the document block to the selected at least one chat. In this way, the user can complete document block sharing without switching between the document and the IM client, thereby simplifying the operation.

FIG. 4 is an exemplary flowchart of another document block sharing method provided in an embodiment of the present disclosure, the document block sharing method is applied to the document side, and based on the method of FIG. 3, the document block sharing method may include, but is not limited to, the following step 201 and step 202:

In step 201, permission information of the document block is acquired.

In the present embodiment, in response to a selection operation on the document block in the first document, the permission information of the document block is acquired. The permission information includes, for example, but is not limited to, a readable permission, an editable permission (including a reading permission and a comment permission), a commentable permission, a combined permission thereof, no permission, etc.

In some embodiments, when the permission information of the document block is acquired, permission information of the first document may be acquired as the permission information of the document block. For example, different members in the target chat have different permissions for the first document, some members have an editing permission for the first document, and some members have a reading permission for the first document, so that these permissions are synchronized to the permissions of the document block.

In some other embodiments, when the permission information of the document block is acquired, a permission setting interface of the document block may be presented, and the permission information of the document block is acquired based on an operation on the permission setting interface. When the first document includes a plurality of document blocks, permissions for the document blocks are set uniformly or separately in the permission setting interface.

In step 202, the permission information is synchronized to a system to which the target business scenario belongs, so that the system presents the document block in the target business scenario based on the permission information.

Taking it as an example that the business scenario is a chat in IM, in response to a sharing confirmation operation, the document block is sent to the target chat, and the permission information is synchronized to a communication system where the target chat is located, so that the communication system presents the document block in the target chat based on the permission information.

For example, the communication system displays part or all of the document block in the IM client based on the permission information being a readable permission or an editable permission; or, the communication system displays, in the IM client and based on the permission information being no permission, prompt information of applying for a permission.

In some embodiments, a first permission for the document block may be assigned to members in the target chat, and the first permission is to assign the same permission to the members in the target chat, or to assign different permissions the members in the target chat. The first permission may be a readable permission, an editable permission, a commentable permission, a combined permission thereof, no permission, and the like. In response to an operation of withdrawing the sent document block in the target chat, the first permission assigned to the members in the target chat for the document block is revoked. For example, an editing permission for the document block may be assigned to a part of members in the target chat, and a reading permission for the document block may be assigned to the other part of members in the target chat.

In some embodiments, a first permission for the first document is also assigned to the members in the target chat while assigning the first permission for the document block to the members in the target chat. In response to the operation of withdrawing the sent document block in the target chat, the first permission for the document block and the first permission for the first document, which are assigned to the members in the target chat, are revoked. That is, in the present embodiment, the permissions for the document block and the first document are kept consistent for the same user.

In some embodiments, in response to a trigger operation of a first user for the document block in the target chat, the first document is presented for the first user, and a location of the document block is positioned to. The first user is a member in the target chat. In this way, when the user opens the first document, the location of the document block in the first document is directly positioned to, thereby facilitating the view of the user.

FIG. 5 is an exemplary flowchart of still another document block sharing method provided in an embodiment of the present disclosure, and the document block sharing method is applied to the document side. As shown in FIG. 5, the document block sharing method may include, but is not limited to, the following steps 301 to 303:

In step 301, in response to a selection operation on a document block in a first document, a document block operation option box is presented, and the document block operation option box includes an option of sharing to a chat.

In the present embodiment, the selection operation on the document block is, for example, a framing operation or a long-press dragging operation.

In the present embodiment, in response to the user selecting the document block in the first document via the framing operation, information of the document block may be acquired, and the information of the document block may include, but is not limited to, content of the document block, and typesetting information and layout information of the content of the document block in the first document, link address information of a document to which the document block belongs, etc.

It can be seen that in the present embodiment, the selection operation on the document block may be performed in the first document to replace a screenshot operation, and the information of the document block instead of a screenshot is obtained, thereby facilitating direct editing and comment on the content of the document block subsequently.

In the present embodiment, after the user selects the document block, the document block operation option box is presented in the document page, and since the document block operation option box includes the option of sharing to the chat, the user clicks the option of sharing to the chat to achieve the effect of directly sharing the document block to the chat on the document page, and the sharing is completed without switching from the document to the IM client, thereby simplifying the sharing operation.

In step 302, in response to an operation of triggering the option of sharing to the chat, a sharing interface is presented, and the sharing interface includes an instant message chat list and a sending control.

In the present embodiment, the sharing interface including the instant message chat list is presented, so that the user can select at least one chat from the instant message chat list for document block sharing. In addition, after confirming that the selected chat is correct, the user may execute a sharing confirmation operation, for example, click the sending control.

In step 303, in response to an operation of triggering the sending control, the document block is sent to at least one chat selected by the user in the instant message chat list.

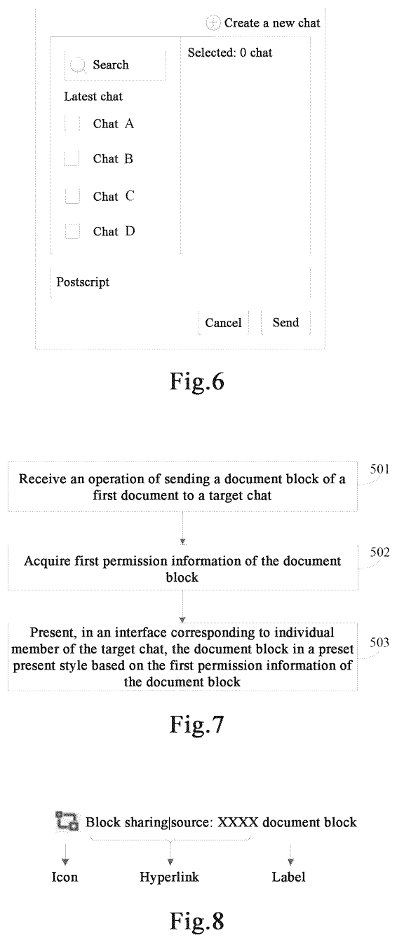

FIG. 6 is a schematic diagram of a sharing interface provided in an embodiment of the present disclosure. In FIG. 6, the sharing interface includes an instant message chat list, a latest chat is displayed by default, and the instant message chat list includes a chat A, a chat B, a chat C and a chat D. The user may click a search box to search for any chat, the chat selected by the user is displayed in a selected area, and in FIG. 6, the selected chat is 0.

In FIG. 6, the sharing interface further includes “create a new chat” control, when the user clicks the “create a new chat” control, a new chat may be created, and the created new chat is displayed in the selected area.

In FIG. 6, the sharing interface further includes a postscript box, so that the user can input a postscript. In response to the sharing confirmation operation (for example, the user clicks the sending control), a postscript input into the postscript box of the sharing interface is acquired, and the postscript and the document block are sent to the target chat together.

FIG. 7 is an exemplary flowchart of a document block sharing method provided in an embodiment of the present disclosure, an execution body of the document block sharing method is an IM client, that is, the document block sharing method is applied to an IM side.

The document block sharing method may include, but is not limited to, the following steps 501 to 503:

In step 501, an operation of sending a document block of a first document to a target chat is received.

In the present embodiment, the operation of sending the document block of the first document to the target chat is received, information of the document block may be acquired, and the information of the document block includes, but is not limited to: content of the document block, typesetting information and layout information of the content of the document block in the first document, link address information of a document to which the document block belongs, etc.

In step 502, first permission information of the document block is acquired.

In the present embodiment, the first permission information of the document block may be a readable permission, an editable permission, a commentable permission, a combined permission thereof, no permission, etc.

In step 503, in an interface corresponding to individual member of the target chat, the document block is presented in a preset present style based on the first permission information of the document block.

In some embodiments, in a case where a current user in the target chat has a readable permission or an editable permission for the document block in the first permission information, part or all of content of the document block is displayed in the target chat of the current user; or in a case where the current user in the target chat has no permission for the document block in the first permission information, prompt information of applying for a permission is displayed in the target chat of the current user.

The preset present style includes a text hyperlink and a message card.

In the present embodiment, the text hyperlink and the message card are generated based on the information of the document block.

The text hyperlink refers to a link represented in the form of a character string composed of characters instead of English letters and punctuation marks. When the text hyperlink is triggered, a browser may be opened, and a page corresponding to the link is skipped to, and the page is a page where the document is located. Meanwhile, the text used in the text hyperlink may reflect core content of the page corresponding to the link.

The message card refers to a card form presentation for presenting related information of the content of the document block. The content presented by the message card may be understood as a summary of the content of the document block.

It can be seen that in the present embodiment, the message card including the text hyperlink is displayed in an interface of the chat, and key information, summary information and core information of the content of the document block are substantially presented by using the message card, so as to help the user to quickly learn about the content of the document block, so that the content of the document block can be directly consumed without skipping, thereby improving the consumption efficiency of the content of the document block.

FIG. 8 is a schematic structural diagram of a text hyperlink provided in an embodiment of the present disclosure, as shown in FIG. 8, the text hyperlink includes at least one of the following:
an icon, which is a mark pattern of a document block;
a hyperlink, which is a hyperlink constructed based on text content (e.g., a topic/abstract) extracted from the information of the document block or text content defined by a business server of the information of the document block, and after the hyperlink is triggered, the browser is opened and is skipped to a document corresponding to the information of the document block; and
a label, which is used for identifying a document type corresponding to the information of the document block.

In the present embodiment, the hyperlink is “block sharing|source: XXXX”, and “XXXX” denotes a document name of a document where the document block is located. It can be seen that the hyperlink seen by the user is a text hyperlink, therefore it is easier to understand the source of the document corresponding to the hyperlink.

In some embodiments, in response to a mouse pointer hovering over the hyperlink, an underline is added below the hyperlink, and further, in response to an operation of the user clicking the mouse, the browser is opened and skipped to the document corresponding to the document block information.

In some embodiments, in response to a right click of the user when the mouse pointer hovers over the text hyperlink, the text hyperlink is selected, and an operation bar is popped up, and the operation bar includes a copy link control and a copy control. The copy link control is used for copying the hyperlink (which may be understood as a URL (Uniform Resource Locator) link); and the copy control is used for copying the text content of the text hyperlink. For example, when the user clicks the copy control, and text content in FIG. 8: “block sharing|source: XXXX” is substantially copied.

In some embodiments, in response to the mouse pointer framing the entire text hyperlink, the hyperlink (which may be understood as the URL link) is copied; and in response to the mouse pointer framing a part of the entire text hyperlink, the framed text content is copied.

In some embodiments, in response to a long press (for example, a long press of the user on a mobile terminal device), a message menu is presented. The message menu includes a copy link control and a copy control, and the copy link control is used for copying the hyperlink (which may be understood as the URL link); and the copy control is used for copying the text content of the text hyperlink.

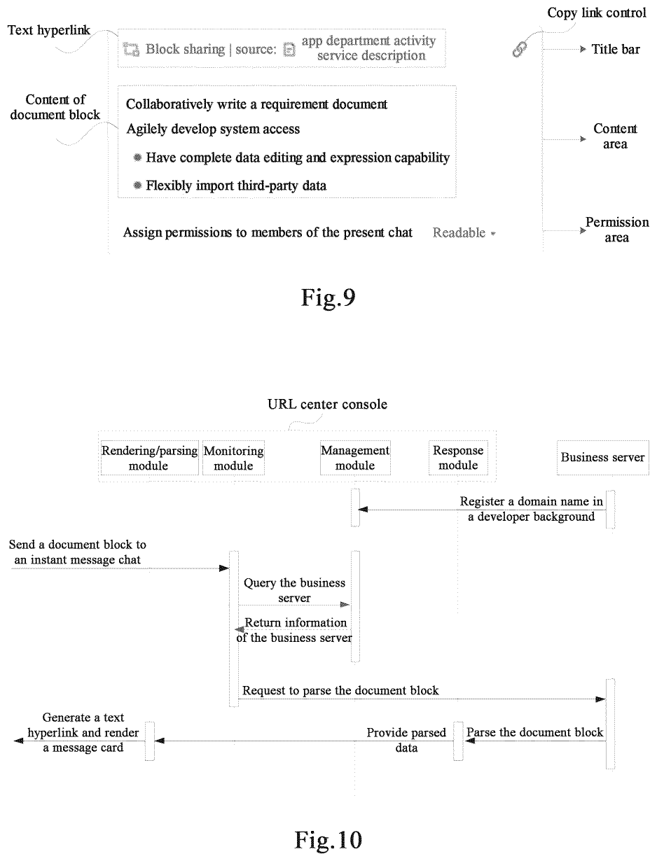

FIG. 9 is a schematic diagram of a preset present style of a message card provided in an embodiment of the present disclosure, and as shown in FIG. 9, the preset display style includes at least one of the following:
a title bar, including a text hyperlink;
a content area, in which part or all of content of the document block is displayed; or
a permission area, including a permission setting control, and the permission setting control is used by the current user to set a permission of a chat member for the document block, or the permission area is used for displaying a permission of the current user for the document block. The permission includes, but is not limited to, a readable permission, an editable permission (including a reading permission and a comment permission), a commentable permission, combined permission thereof, no permission, etc.

In some embodiments, a sharer of the document block may set the permission of the chat member for the document block via the permission setting control. In some embodiments, a recipient of the document block, that is, a member other than the sharer in the chat, may see the permission of the recipient for the document block, which is displayed in the permission area.

In FIG. 9, the title bar further includes a copy link control, and the copy link control is located after the text hyperlink. In response to an operation of triggering the duplicate link control (e.g., the user clicks the copy link control), the hyperlink (which may be understood to be the URL link) is copied.

In FIG. 9, the content of the document block displayed in the content area retains the typesetting information and layout information, such as a font, a font size, a paragraph spacing and the like, in the original document.

In FIG. 9, prompt information of “assigning a permission to the chat member” is displayed in the permission area, so as to prompt the user to set the permission of the chat member. The permission setting control included in the permission area is a pull-down list control, and the pull-down list control includes a plurality of options: readable, editable, and the like.

In some embodiments, the content of the document block is a screenshot, and in response to an operation of triggering the content of the document block (e.g., the user click the screenshot), the browser is opened and skipped to the document corresponding to the information of the document block.

In some embodiments, in response to an operation of triggering the document block presented in the target chat, the browser is opened and skipped to the first document corresponding to the document block. In some embodiments, before opening the browser and skipping to the first document corresponding to the document block, it may be determined whether a user triggering the operation has at least a reading permission for the first document, if so, the operation of opening the browser and skipping to the first document corresponding to the document block is executed, and otherwise, prompt information of applying for a permission for the first document is presented.

In some embodiments, in response to an editing operation or a commenting operation on the document block in the target chat, it is detected whether a member performing the editing operation or the commenting operation has an editable permission, and if so, the edited content or commented content is added into the document block in the target chat. Further, after the edited content or commented content is added into the document block, the edited content or commented content is synchronized into the first document.

FIG. 10 is an exemplary flowchart of still another document block sharing method provided in an embodiment of the present disclosure, an execution body of the method is a URL center console, and the URL center console may be understood as a service center console for processing a related event of a URL in an instant message system. The URL center console acquires an input of a user via an instant message client (i.e., an IM client), and presents a processing result of the URL to a customer via the instant message client.

FIG. 10 is an embodiment based on FIG. 7, after receiving the operation of sending the document block of the first document to the target chat in step 701 of FIG. 7, in response to the operation of sending the document block of the first document to the target chat, the document block is parsed to generate a text hyperlink corresponding to the document block, and a message card corresponding to the document block is rendered in a preset present style.

As shown in FIG. 10, the URL center console may be divided into a plurality of functional modules: a rendering/parsing module, a monitoring module, a management module and a response module. FIG. 10 further includes a business server, and the business server is a server for providing a document service. The business server needs to register a domain name in a developer background at first, so as to access the management module of the URL center console. The process of the document block sharing method is described as follows:

A document block is sent to an instant message chat. After monitoring the document block, the monitoring module queries the management module for a business server for processing the document block. The management module returns queried information of the business server to the monitoring module. The monitoring module requests to parse the document block from the queried business server. The business server parses the document block in response to the request, and sends parsed data to the response module. The response module receives the parsed data fed back by the business server and provides the parsed data for the rendering/parsing module. After acquiring the parsed data, the rendering/parsing module generates, based on the parsed data, a text hyperlink corresponding to the document block, and renders, in a preset present style, a message card corresponding to the document block.

In the above technical solution, key information, summary information and core information of content of the document block are substantially presented by using the message card, so as to help the user to quickly learn about the content of the document block, so that the content of the document block can be directly consumed without skipping, thereby improving the consumption efficiency of the content of the document block.

It should be noted that, regarding the foregoing method embodiments, for simple description, all the foregoing method embodiments are expressed as a series of action combinations, but those skilled in the art can understand that the embodiments of the present disclosure are not limited by the described action sequence, because some steps may be performed in other sequences or simultaneously according to the embodiments of the present disclosure. In addition, those skilled in the art can understand that the embodiments described in the specification are all optional embodiments.

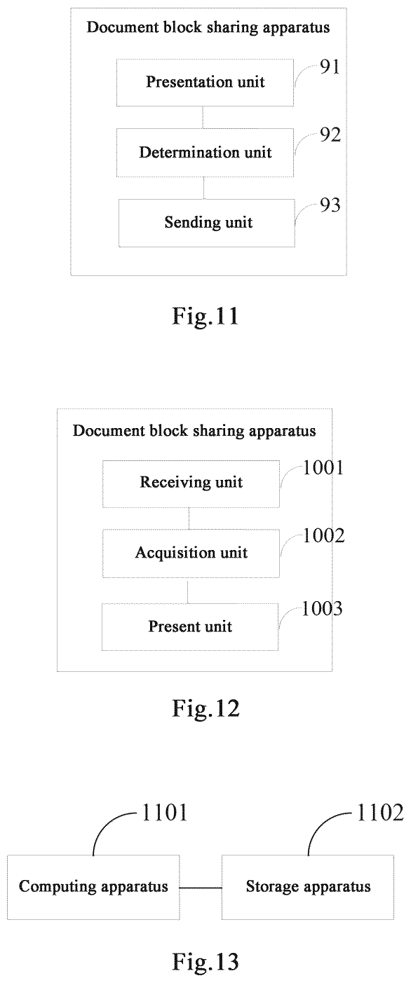

FIG. 11 is an exemplary block diagram of a document block sharing apparatus provided in an embodiment of the present disclosure, and the document block sharing apparatus is applied to a document side. The document block sharing apparatus may include, but is not limited to, a presentation unit 91, a determination unit 92 and a sending unit 93.

The presentation unit 91 is configured to present a sharing interface in response to a sharing operation triggered for a document block in a first document.

The determination unit 92 is configured to determine a target business scenario based on a selection operation on the sharing interface.

The sending unit 93 is configured to: in response to a sharing confirmation operation, send a document block indicated by the sharing operation to the target business scenario, and the document block indicated by the sharing operation includes one or more document blocks.

In some embodiments, the determination unit 92 is configured to determine a target chat based on a chat selection operation on the sharing interface. The sending unit 93 is configured to send, to the target chat, the document block indicated by the sharing operation.

In some embodiments, the presentation unit 91 is further configured to: present a document block operation option box in response to a selection operation on the document block in the first document, and the document block operation option box includes an option of sharing to a chat.

In some embodiments, the document block sharing apparatus further includes an acquisition unit 94 and a permission unit 95. The acquisition unit 94 is configured to acquire permission information of the document block. The permission unit 95 is configured to synchronize the permission information to a system to which the target business scenario belongs, so that the system presents the document block in the target business scenario based on the permission information.

In some embodiments, the acquisition unit 94 is configured to acquire permission information of the first document as the permission information of the document block; or present a permission setting interface of the document block, and acquire the permission information of the document block based on an operation on the permission setting interface. When the first document includes a plurality of document blocks, permissions for the document blocks are set uniformly or separately in the permission setting interface.

In some embodiments, the document block sharing apparatus further includes an assigning unit 96, configured to assign a first permission of the document block to members in the target chat, wherein the first permission is to assign the same permission to the members in the target chat, or to assign different permissions the members in the target chat. In some embodiments, the assigning unit 96 is configured to further assign a first permission of the first document to the members in the target chat while assigning the first permission of the document block to the members in the target chat.

In some embodiments, the document block sharing apparatus further includes a revoking unit 97, configured to: in response to an operation of withdrawing the sent document block in the target chat, revoke the first permission assigned by the assigning unit 96 to the members in the target chat for the document block.

In some embodiments, the document block sharing apparatus further includes a postscript unit 98, configured to: in response to the sharing confirmation operation, acquire a postscript input into a postscript box of the sharing interface, and send the postscript into the target chat.

In some embodiments, the presentation unit 91 is further configured to: in response to a trigger operation of a first user for the document block in the target chat, present the first document to the first user, and position to a location of the document block.

FIG. 12 is an exemplary block diagram of another document block sharing apparatus provided in an embodiment of the present disclosure, and the document block sharing apparatus is applied to an IM client. The document block sharing apparatus may include, but is not limited to, a receiving unit 1001, an acquisition unit 1002 and a presentation unit 1003:

The receiving unit 1001 is configured to receive an operation of sending a document block of a first document to a target chat.

The acquisition unit 1002 is configured to acquire first permission information of the document block.

The presentation unit 1003 is configured to: in an interface corresponding to individual member of the target chat, present the document block in a preset present style based on the first permission information of the document block.

In some embodiments, the preset present style includes: a text hyperlink and a message card; and the presentation unit 1003 is further configured to: in response to the operation of sending the document block of the first document to the target chat, parse the document block, generate a text hyperlink corresponding to the document block, and render, in the preset present style, a message card corresponding to the document block.

In some embodiments, the preset display style includes at least one of the following:
a title bar, including the text hyperlink;
a content area, in which part or all of content of the document block is displayed; or
a permission area, including a permission setting control, wherein the permission setting control is used by the current user to set a permission of a chat member for the document block, or the permission area is used for displaying a permission of the current user for the document block.

In some embodiments, the document block sharing apparatus further includes a skipping unit 1004, configured to: in response to an operation of triggering the document block presented in the target chat, open a browser and skip to the first document corresponding to the document block.

In some embodiments, the skipping unit 1004 is further configured to: determine whether a user triggering the operation has at least a reading permission for the first document; if so, execute the operation of opening the browser and skipping to the first document corresponding to the document block; and otherwise, present prompt information of applying for a permission for the first document.

In some embodiments, the presentation unit 1003 is configured to: in a case where the current user in the target chat has a readable permission or an editable permission for the document block in the first permission information, display part or all of content of the document block in the target chat of the current user; or in a case where the current user in the target chat has no permission for the document block in the first permission information, display, in the target chat of the current user, prompt information of applying for a permission.

In some embodiments, the document block sharing apparatus further includes: an editing unit 1005, configured to: in response to an editing operation or a commenting operation on the document block in the target chat, detect whether a member performing the editing operation or the commenting operation has an editable permission, and if so, add edited content or commented content into the document block in the target chat.

In some embodiments, the editing unit 1005 is further configured to, after adding the edited content or commented content into the target chat, synchronize the edited content or commented content into the first document.

It should be noted that the division of various units in the document block sharing apparatus is only a logic function division, there may be other division manners in practical implementation, for example, at least two units may be implemented as one unit; and the units in the document block sharing apparatus may also be divided into a plurality of sub-units. It can be understood that the units or sub-units may be implemented by electronic hardware or a combination of computer software and electronic hardware. Whether these functions are executed by hardware or software depends on particular applications and design constraint conditions of the technical solutions. Those skilled in the art may use different methods to implement the described functions for each particular application.

FIG. 13 is an exemplary block diagram of a system including at least one computing apparatus and at least one storage apparatus for storing an instruction provided in an embodiment of the present disclosure. In some embodiments, the system may be used for big data processing, and the at least one computing apparatus and the at least one storage apparatus may be deployed in a distributed manner, so that the system is a distributed data processing cluster.

As shown in FIG. 13, the system includes at least one computing apparatus 1101 and at least one storage apparatus 1102 for storing an instruction. It can be understood that the storage apparatus 1102 in the present embodiment may be a volatile memory or a non-volatile memory, or may include both the volatile memory and the non-volatile memory.

In some embodiments, the storage apparatus 1102 stores the following elements: executable units or data structures, or subsets thereof, or extended sets thereof: an operating system and an application program.

The operating system includes various system programs, such as a frame layer, a core library layer, a driving layer, and the like, and is configured to implement various basic tasks and process hardware-based tasks. The application program includes various application programs, for example, a media player, a browser, and the like, and is configured to implement various application tasks. A program for implementing at least one document block sharing method provided in the embodiments of the present disclosure may be included in the application program.

In the embodiments of the present disclosure, the at least one computing apparatus 1101 invokes a program or an instruction stored in the at least one storage apparatus 1102, specifically may be a program or an instruction stored in the application program, and the at least one computing apparatus 1101 is configured to execute the steps of at least one document block sharing method provided in the embodiments of the present disclosure.

The document block sharing method provided in at least one embodiment of the present disclosure may be applied to the computing apparatus 1101 or implemented by the computing apparatus 1101. The computing apparatus 1101 may be an integrated circuit chip, which has a signal processing capability. In an implementation process, the steps of the above method may be completed by using an integrated logic circuit of hardware in the computing apparatus 1101 or an instruction in a form of software. The computing apparatus 1101 may be a general-purpose processor, a digital signal processor (DSP), an application specific integrated circuit (ASIC), a field programmable gate array (FPGA) or other programmable logic devices, a discrete gate or transistor logic device, or a discrete hardware component. The general-purpose processor may be a micro-processor, or the processor may also be any conventional processor, etc.

The steps of the document block sharing method provided in at least one embodiment of the present disclosure may be directly executed and completed by a hardware decoding processor, or may be executed and completed by using a combination of hardware and software units in a decoding processor. The software unit may be located in a mature storage medium in the art, such as a random access memory, a flash memory, a read-only memory, a programmable read-only memory, an electrically erasable programmable memory, or a register, or the like. The storage medium is located in the storage apparatus 1102, and the computing apparatus 1101 reads information in the storage apparatus 1102 and completes the steps of the method in combination with the hardware of the storage apparatus 1102.

An embodiment of the present disclosure further provides a computer-readable storage medium, wherein the computer-readable storage medium stores a program or an instruction, and when the program or the instruction is operated by at least one computing apparatus, the at least one computing apparatus is caused to execute the steps of the embodiments of the document block sharing method, which will not be repeated here to avoid repeated description. The computing apparatus may be the computing apparatus 1101 shown in FIG. 11. In some embodiments, the computer-readable storage medium is a non-transitory computer-readable storage medium.

An embodiment of the present disclosure further provides a computer program product, wherein the computer program product includes a computer program, the computer program is stored in a non-transitory computer-readable storage medium, and at least one processor of a computer reads the computer program from the storage medium and executes the computer program, so that the computer executes the steps of the embodiments of the document block sharing method, which will not be repeated here to avoid repeated description.

It should be noted that herein, the terms “include”, “contain” or any other variants thereof are intended to cover non-exclusive inclusions, such that a process, a method, an article or an apparatus including a series of elements not only includes those elements, but also includes other elements that are not explicitly listed, or also includes elements inherent to such a process, method, article or apparatus. If there are no more restrictions, the element defined by the sentence “including a . . . ” does not exclude the existence of other identical elements in the process, the method, the article or the apparatus that includes the element.

It can be understood by those skilled in the art that, although some embodiments described herein include certain features included in other embodiments rather than other features, combinations of features of different embodiments are meant to be within the scope of the present disclosure and form different embodiments.

It can be understood by those skilled in the art that, the description of each embodiment has its own emphasis, and for a part that is not described in detail in a certain embodiment, reference may be made to related descriptions of other embodiments.

Although the embodiments of the present disclosure are described in combination with the drawings, those skilled in the art may make various modifications and variations without departing from the spirit and scope of the present disclosure, and such modifications and variations fall within the scope defined by the appended claims.

1. A document block sharing method, comprising:
presenting a sharing interface in response to a sharing operation triggered for a document block in a first document;
determining a target business scenario based on a selection operation on the sharing interface; and
in response to a sharing confirmation operation, sending a document block indicated by the sharing operation to the target business scenario,
wherein the document block indicated by the sharing operation comprises one or more document blocks.

2. The method according to claim 1, wherein,
determining the target business scenario based on the selection operation on the sharing interface comprises: determining a target chat based on a chat selection operation on the sharing interface; and
sending the document block indicated by the sharing operation to the target business scenario comprises: sending, to the target chat, the document block indicated by the sharing operation.

3. The method according to claim 2, wherein the method further comprises: before presenting the sharing interface in response to the sharing operation triggered for the document block in the first document,
presenting a document block operation option box in response to a selection operation on the document block in the first document, wherein the document block operation option box comprises an option of sharing to a chat.

4. The method according to claim 1, wherein the method further comprises:
acquiring permission information of the document block; and
synchronizing the permission information to a system to which the target business scenario belongs, so that the system presents the document block in the target business scenario based on the permission information.

5. The method according to claim 4, wherein acquiring the permission information of the document block comprises:
acquiring permission information of the first document as the permission information of the document block; or
presenting a permission setting interface of the document block, and acquiring the permission information of the document block based on an operation on the permission setting interface, wherein when the first document comprises a plurality of document blocks, permissions for the document blocks are set uniformly or separately in the permission setting interface.

6. The method according to claim 2, wherein the method further comprises:
assigning a first permission for the document block to members in the target chat, wherein the first permission is to assign the same permission to the members in the target chat, or to assign different permissions the members in the target chat.

7. The method according to claim 6, wherein the method further comprises at least one of the following:
in response to an operation of withdrawing the sent document block in the target chat, revoking the first permission assigned to the members in the target chat for the document block;
further assigning a first permission for the first document to the members in the target chat while assigning the first permission for the document block to the members in the target chat.

8. (canceled)

9. The method according to claim 2, wherein the method further comprises at least one of the following:
after presenting the sharing interface in response to the sharing operation triggered for the document block in the first document, in response to the sharing confirmation operation, acquiring a postscript input into a postscript box of the sharing interface, and sending the postscript into the target chat;
in response to a trigger operation of a first user for the document block in the target chat, presenting the first document to the first user, and positioning to a location of the document block.

10. (canceled)

11. A document block sharing method, comprising:
receiving an operation of sending a document block of a first document to a target chat;
acquiring first permission information of the document block; and
presenting, in an interface corresponding to individual member of the target chat, the document block in a preset present style based on the first permission information of the document block.

12. The method according to claim 11, wherein,
the preset present style comprises: a text hyperlink and a message card; and
the method further comprises: after receiving the operation of sending the document block of the first document to the target chat,
in response to the operation of sending the document block of the first document to the target chat, parsing the document block, generating a text hyperlink corresponding to the document block, and rendering, in the preset present style, a message card corresponding to the document block.

13. The method according to claim 12, wherein the preset present style comprises at least one of the following:
a title bar, comprising the text hyperlink;
a content area, in which part or all of content of the document block is displayed; or
a permission area, comprising a permission setting control, wherein the permission setting control is used by a current user to set a permission of a chat member for the document block, or the permission area is used for displaying a permission of the current user for the document block.

14. The method according to claim 11, wherein the method further comprises:
in response to an operation of triggering the document block presented in the target chat, opening a browser and skipping to the first document corresponding to the document block.

15. The method according to claim 14, wherein the method further comprises: before opening the browser and skipping to the first document corresponding to the document block,
determining whether a user triggering the operation has at least a reading permission for the first document; if so, executing the operation of opening the browser and skipping to the first document corresponding to the document block; and otherwise, presenting prompt information of applying for a permission for the first document.

16. The method according to claim 11, wherein presenting, in the interface corresponding to individual member of the target chat, the document block in the preset present style based on the first permission information of the document block, comprises:
in a case where a current user in the target chat has a readable permission or an editable permission for the document block in the first permission information, displaying part or all of content of the document block in the target chat of the current user; or
in a case where the current user in the target chat has no permission for the document block in the first permission information, displaying, in the target chat of the current user, prompt information of applying for a permission.

17. The method according to claim 11, wherein the method further comprises:
in response to an editing operation or a commenting operation on the document block in the target chat, detecting whether a member performing the editing operation or the commenting operation has an editable permission, and if so, adding edited content or commented content into the document block in the target chat.

18. The method according to claim 17, wherein the method further comprises:
after adding the edited content or commented content into the document block in the target chat, synchronizing the edited content or commented content into the first document.

19-20. (canceled)

21. A system, comprising at least one computing apparatus and at least one storage apparatus for storing an instruction, wherein the instruction, when operated by the at least one computing apparatus, causes the at least one computing apparatus to:
present a sharing interface in response to a sharing operation triggered for a document block in a first document;
determine a target business scenario based on a selection operation on the sharing interface; and
in response to a sharing confirmation operation, send a document block indicated by the sharing operation to the target business scenario,
wherein the document block indicated by the sharing operation comprises one or more document blocks.

22. A non-transitory computer-readable storage medium, wherein the computer-readable storage medium stores a program or an instruction, and the program or the instruction, when operated by at least one computing apparatus, causes the at least one computing apparatus to execute the steps of the document block sharing method according to claim 1.

23. A system, comprising at least one computing apparatus and at least one storage apparatus for storing an instruction, wherein the instruction, when operated by the at least one computing apparatus, causes the at least one computing apparatus to execute the steps of the document block sharing method according to claim 11.

24. A non-transitory computer-readable storage medium, wherein the computer-readable storage medium stores a program or an instruction, and the program or the instruction, when operated by at least one computing apparatus, causes the at least one computing apparatus to execute the steps of the document block sharing method according to claim 11.
